(19) United States
(12) Patent Application Publication
(10) Pub. No.: US 2013/0332848 A1
(43) Pub. Date: Dec. 12, 2013

(54) CREATING NEW CONNECTIONS ON SOCIAL NETWORKS USING GESTURES

(71) Applicants: Wilfred LAM, Los Altos, CA (US); Rakesh RAMDE, Los Altos, CA (US)

(72) Inventors: Wilfred LAM, Los Altos, CA (US); Rakesh RAMDE, Los Altos, CA (US)

(21) Appl. No.: 13/843,661

(22) Filed: Mar. 15, 2013

Related U.S. Application Data
(60) Provisional application No. 61/689,464, filed on Jun. 6, 2012.

(51) Int. Cl. G06F 3/01

(52) U.S. Cl. CPC G06F 3/017
USPC 715/751

(57) ABSTRACT

Techniques for creating new connections on a social network using gestures. A server receives a first fingerprint of a gesture detected on a device of a first user. The gesture is indicative of the first user initializing a new social networking connection with a second user. The first fingerprint is matched to a second fingerprint received from the second user. In response to the matching, a connection is initiated between the first and second users on a social network in response to the matching. The user devices include an accelerometer to detect the gesture.

### CROSS-REFERENCES TO RELATED APPLICATIONS

This application claims priority under 35 USC 119(e) to U.S. Pat. App. No. 61/689,464, entitled METHOD AND APPARATUS FOR CREATING NEW CONNECTION ON A SOCIAL NETWORK, by Wilfred Lam et al., the contents of which are being hereby incorporated by reference in its entirety.

### FIELD OF THE INVENTION

The invention relates generally to social networking, and more specifically, to creating new connections on a social network.

### BACKGROUND OF THE INVENTION

Social networking has become one of the major applications used over the Internet. Millions of users have joined leisure social networking web sites such as Facebook as well as professional social networking web sites such as LinkedIn. Typically, in order to establish a new connection between two users, one of the users sends an invitation to connect, or selects an add where consent is not needed to connect. Afterwards, the users may automatically share information such as status updates or photographs posted to the web site.

Unfortunately, the process of adding new connections is disjointed from the real life event of connecting with people. In other words, a connection is first made in real life to an old friend or co-worker, and then later that connection can be consummated through a social networking web site. To do so, the new contact's name must be known and correctly spelled in order to search through users of a social networking web site. An invite is sent out and accepted asynchronously when the new contact logs on and addresses the invite. Each social networking web site is accessed separately to establish the same new contact. Clearly, there is also lots of room for error that can prevent a successful connection with the new contact.

What is needed is a technique for creating new connections on a social network, while overcoming the deficiencies of the prior art.

### SUMMARY

To meet the above-described needs, methods, computer program products, and systems for creating social networking connections with a gesture.

In one embodiment, a server receives a first fingerprint of a gesture detected on a device of a first user. The gesture is indicative of the first user initializing a new social networking connection with a second user. The first fingerprint comprises at least an identification of the first user and a location of the device.

In another embodiment, the first fingerprint is matched to a second fingerprint received from the second user. The second fingerprint comprises at least an identification of the second user and a location of the second device, wherein the locations of the first and second devices are substantially matching. In response to the matching, a connection is initiated between the first and second users on a social network in response to the matching.

In yet another embodiment, user device includes an accelerometer to detect a gesture indicative of the first user initializing a new contact. The user device generates the first fingerprint and transmits it to the server for matching.

A gesture can connect local users that are meeting in person by, for example, bumping user devices against each other. Alternatively, the gesture can connect remote users that are otherwise in contact, such as two Skype users that are in session and want to connect. In the remote case, the gesture can be from a user's own user device.

Advantageously, social connections are automated in real-time with a physical connection.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to create social networking connections with gestures, according to one embodiment.

FIG. 2 is a more detailed block diagram illustrating a user device of FIG. 1, according to one embodiment.

FIG. 3 is a more detailed block diagram illustrating a connections server of FIG. 1, according to one embodiment.

FIG. 4 is a high-level flow diagram illustrating a method for creating social networking connections with gestures, according to one embodiment.

FIG. 5 is a flow diagram illustrating a step for matching connection fingerprints of FIG. 4, according to one embodiment.

FIG. 6 is a block diagram illustrating an exemplary computing device, according to one embodiment, according to one embodiment.

### DETAILED DESCRIPTION

The present invention provides methods, computer program products, and systems for creating social networking connections with gestures. Generally, a social networking connection refers to a contact, friend, co-worker, relative, fan, celebrity,

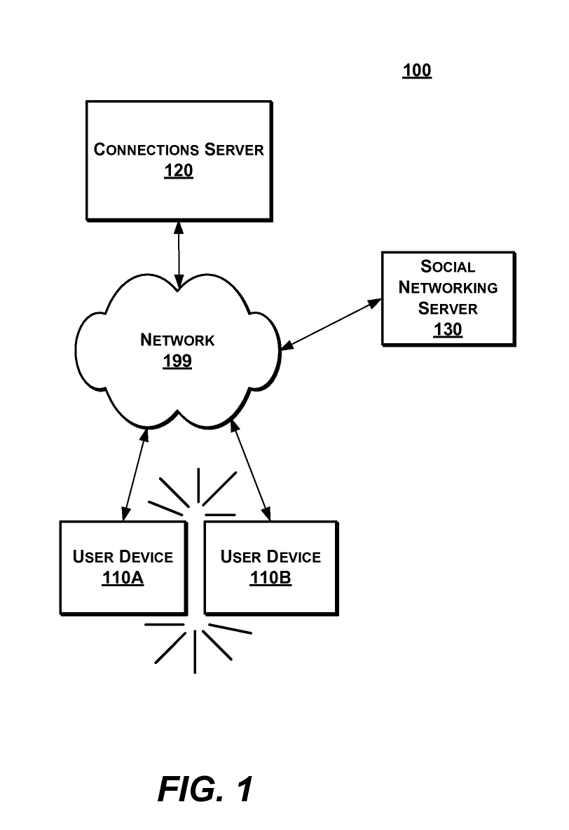

Social Networking Connections Creation Systems (FIGS. 1-3)

FIG. 1 is a high-level block diagram illustrating a system 100 to create social networking connections with gestures, according to one embodiment. The system 100 comprises user devices 110A,B, a connections server 120, and a social networking server 130. Each of the components is coupled in communication via network 199. The data flow starts at the user devices 110A,B which both generate a fingerprint that is sent to the connections server 120 and matched, resulting in a new connection made at the social networking server 130.

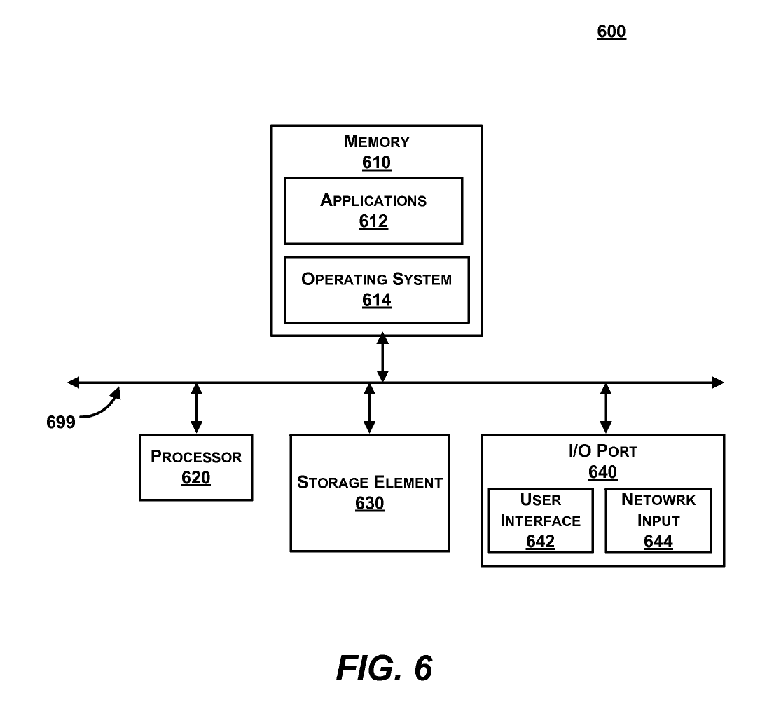

The user devices 110A,B can be, for example, mobile devices, smart phones, tablet computers, personal computers, Internet appliances, or any other appropriate computing devices as described in FIG. 6. Users of user devices 110A,B may meet at a party or be reconnected at a convention, and want to also connect on social networks. In one embodiment, a connection event starts with the users open an application on their respective user devices 110A,B and then perform some type of gesture involving the user devices 110A,B, such as tapping, shaking, vibrating, or bumping against each other. In another embodiment, the user devices 110A,B recognize the gesture without opening a corresponding application, for example, from sleep mode or during operation.

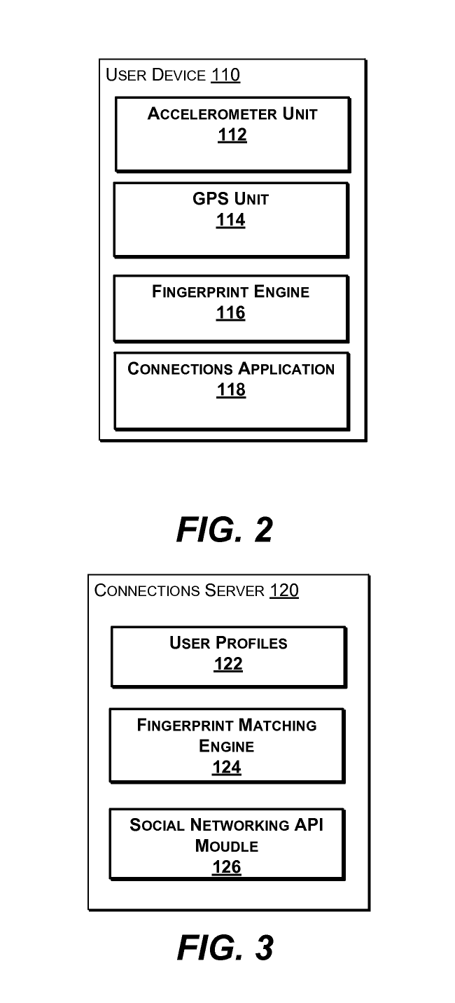

The gesture preferably involves both user devices 110A,B so that a similar fingerprint is generated by each device for matching. The fingerprint, in some embodiments, can include a location, a time, an intensity or other measurement, an identification, and the like. The gesture can connect local users that are meeting in person by, for example, bumping user devices against each other. Alternatively, the gesture can connect remote users that are otherwise in contact with each other, such as two Skype users that are in session and want to connect. In the remote case, the gesture can be from a user's own user device. For example, the two Skype users can initiate a connection mode, or the user can both enter a tap sequence to a touch sensitive screen. The gesture initiates an automated process, described in more detail herein, which connects the users on available social networks. Embodiments of the user devices 110A,B are discussed in more detail below in association with FIG. 2.

The connections server 120 can be one or more server blades, or any appropriate computing device described herein running, for example, an Apache type of server software, including the general computing environment of FIG. 6. The connections server 120 enrolls users by registering information about social networks that users are associated with. After a gesture is received, the connections server 120 attempts to match the gesture with another gesture having similar characteristics, to identify a connection event. User profiles are retrieved for users submitting the matching gestures to determine common social networks. Finally, the connections server 120 can implement a variety of techniques to consummate the connections. In one example, users are automatically connected as friends, followers, fans, or the like, directly at the social networking server 130 through APIs (application programming interfaces). In another example, each user can first be notified of common social networks and be asked to verify that a connection should be made for each particular network. In yet another example, users are invited to join social networks that only one of the users is part of. Furthermore, a status post on one or more of the social networks can indicate that the users were at a common location. One of ordinary skill in the art, given the disclosure herein, will recognize other types of connecting and sharing activities are within the scope of the present invention (e.g., file sharing, contact sharing, check-ins, and the like).

The social networking server 130 can be any of the devices described above with respect to the connections server 120. In an embodiment, the connections server 120 is integrated with the social networking server 130. The social networking server 130 generally hosts a web site or other platform that connects contacts over a digital medium for sharing photographs, job opportunities, links, status updates, and more. Exemplary social networking websites includes Facebook, LinkedIn, Instagram, MySpace, Sound Cloud, Google Circles, and the like. Users of a particular social networking web site can set up a user profile which includes a list of contacts for sharing information with. The contacts can be connected upon demand, require an invitation be accepted, charged a fee for the connection, or be subjected to any implementation-specific policies. In one embodiment, the social networking server 130 allows other systems to submit instructions through APIs. One type of API can receive connection requests. User permission may need to be verified according to some policies.

FIG. 2 is a more detailed block diagram illustrating a user device 110 (representative of both user devices 110A and 110B) of FIG. 1, according to one embodiment. The user device 110 includes an accelerometer unit 112, a GPS unit 114, a fingerprint engine 116 and a connections application 118.

The accelerometer unit 112 can be a semiconductor chip, a MEMS (micro electromechanical systems) device, a spring system, or any other appropriate device for detecting movement associated with a computing device. In one embodiment, the accelerometer unit 112 consists of a basic vibration detector to indicate when vibrations above a certain intensity have been detected (e.g., a spectral density). In another embodiment, the accelerometer unit 112 consists of a semiconductor chip that increases voltage and/ or current output in response to a positioning along X, Y and Z axes. For example, if the accelerometer 112 (and hence, an associated device) are aligned with the X axis, an electrical signal of the X axis would be maximized while an electrical signal of the Y axis and of the Z axis would be minimized. As the accelerometer 112 moves away from the X axis alignment, the balance of electrical signals adjusts accordingly.

In some embodiments, the accelerometer unit 112 is not necessary. Instead of measuring movement, a tap sequence can be entered to the touch screen by a user as a request to connect. In response, the tap sequence is compared against tap sequences of other users for a match.

The GPS unit 114 can determine a current location of a device by processing information received from geophysical satellites. The location of a first user can be matched to the location of a second user to identify a connection event. In alternative embodiments, other processes can be used to determine location, such as IP address, cell phone tower triangulation, location sensors, and the like.

The fingerprint engine 116 can be a processor, logic integrated with the accelerometer unit 112, non-transitory software code for execution, or any other module for generating fingerprints. To do so, the fingerprint engine 116 may interpret signals from a passive accelerometer 112. The fingerprint engine 113 generates fingerprints from the interpreted data or other information provided. The fingerprints may include information from outside the accelerometer 112 as well. For example, the fingerprint engine 116 can be connected to a GPS module in order to determine location.

The connections application (or social networking application) 118 can be a mobile application, a module of an application, a stand-alone application, a cloud-based application, non-transitory software code for execution, or the like. The connections application 118 can be part of a specific social networking application, or can be an aggregation application that is compatible with multiple social networking platforms. In operation, the connections application 118 interfaces with a server (e.g., the connections server 120 of FIG. 1) or directly with social networks. Once the fingerprinting information has been generated by the fingerprinting engine 118, the connections application 116 can send the fingerprint to the server, and receive verification of a connection. In other embodiments, the connections applications 118 can assist in consummating the connection by logging on to a social network. User credentials stored locally may be automatically presented to login the user and send a command to the social network to establish the connection.

FIG. 3 is a more detailed block diagram illustrating a connections server 120 of FIG. 1, according to one embodiment. The connections server 120 includes user profiles 122, a fingerprint matching engine 124, and a social networking API module 126.

The user profiles 122 can be a database of accounts stored locally or remotely. Each user is uniquely identified along with credentials such as a password. Customer user configurations can be stored in the user profiles 122, such as a friends list, or a list of followers/ following or connections. When new connections are made, data in the user profiles 122 is updated.

The fingerprint matching engine 124 receives fingerprints from connections that occur amongst users. Characteristics of the fingerprints are indexed and searched when new fingerprints are received. Some inferences can be made by the fingerprint matching engine 124. For example, two fingerprints can be received at the same time, but have different locations. If no other fingerprints are received from the vicinity, a threshold for distance between users can be relaxed if a potential match exists.

The social networking API module 126 stores APIs for communicating with various social networks. The APIs can be customized for a particular social network, or standardized. There can be one command or many for making new connections.

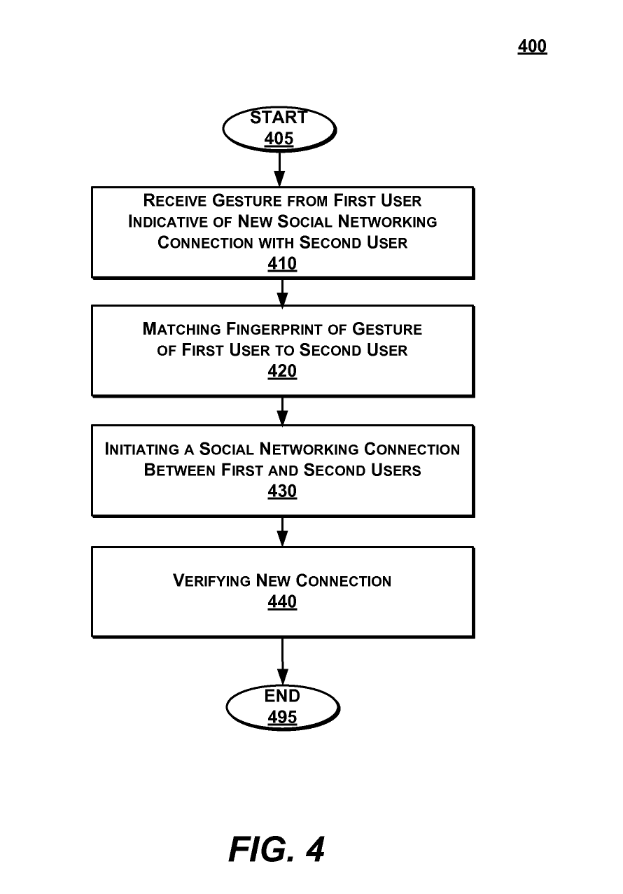

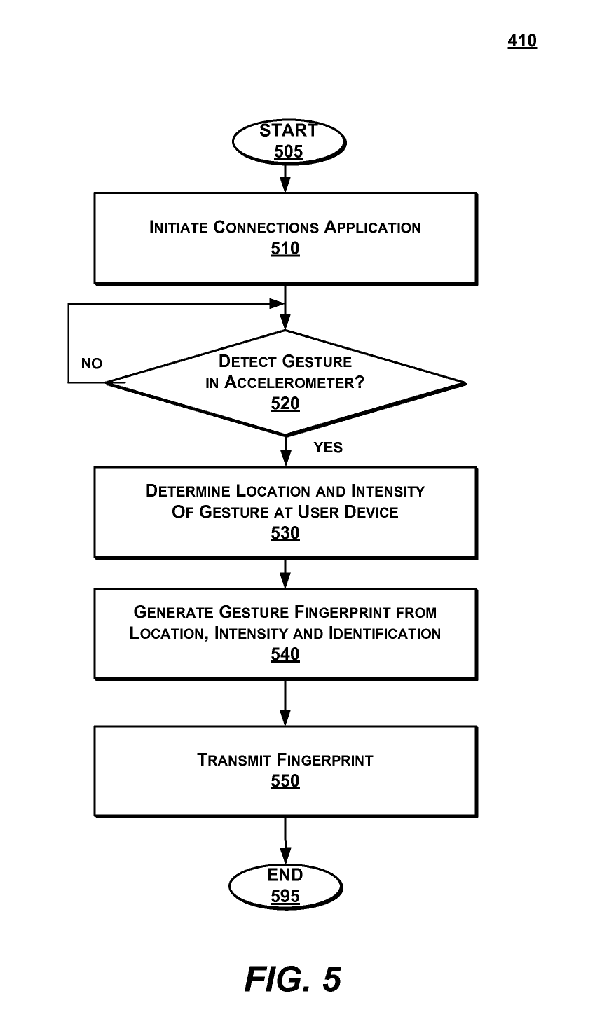

Social Networking Connections Methods (FIGS. 4-5)

FIG. 4 is a high-level flow diagram illustrating a method 400 for creating social networking connections with gestures, according to one embodiment. The method 400 can be implemented, in one embodiment, using the system 100 of FIG. 1. Moreover, the method 300 can be implemented in software, hardware, or a combination of both. The method 400 can be automatically performed (once initialized) without human intervention.

At step 410, a gesture is received from a first user indicative of a new social networking connection desired with a second user. The gesture can be detected by an accelerometer that is always on, or that is activated by opening a connections application. In some embodiments, a special sequence of gestures, such as two bumps 1 second apart, is detected.

At step 420, a fingerprint of a gesture by a first user is matched to a fingerprint of a gesture by a second user. To create a fingerprint, a database record can be completed, fields in a template form can be filled in, a QR-code can be embedded with information, or the like. The information can include any of the characteristics describe herein, or any other information to uniquely identify a connection event for matching.

At step 430, a social networking connection is initiated between the first and second users. In some embodiments, the connection is automatically completed responsive to only a connection event between users. A social networking server is notified of the new connection. In other optional embodiments, the connection is started, but at step 440 needs to be verified by one or both users, and/or by a social network.

FIG. 5 is a flow diagram illustrating the step 410 for matching connection fingerprints of FIG. 4, according to one embodiment.

At optional step 510, a connections application is initiated. In other embodiments, the application is woken up after a gesture is detected. The connection application can be execute as a stand-alone application or as a background process.

At step 520, if a gesture is detected in an accelerometer, at step 530, a location and intensity of the gesture is determined at the user device. Other characteristics can be determined as well.

At step 540, a gesture fingerprint is generated from location, intensity and identification information associated with a user.

At step 550 the fingerprint is transmitted 550 to a server for matching.

Exemplary Computing Device (FIG. 6)

FIG. 6 is a block diagram illustrating an exemplary computing device 600 for use in the system 100 of FIG. 1, according to one embodiment.

The computing device 600, of the present embodiment, includes a memory 610, a processor 620, a storage drive 630, and an I/O port 640. Each of the components is coupled for electronic communication via a bus 699. Communication can be digital and/ or analog, and use any suitable protocol.

The memory 610 further comprises a web application 612 and an operating system 614. Other modules stored in memory can include a web browser application, a web-browser-based application, a mobile application, a streamed application, a locally-installed application, and the like.

The web application 612 can be any of the modules described in FIGS. 2 and 3. The operating system 614 can be one of the Microsoft Windows® family of operating systems (e.g., Windows 2000, Windows XP, Windows XP x64 Edition, Windows Vista, Widows 7, Windows 8, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 620 can be a general purpose processor (CPU), a mobile processor, an application-specific integrated circuit (ASIC), a field programmable gate array (FPGA), a reduced instruction set controller (RISC) processor, an integrated circuit, or the like. A video processor can be optimized for repeated operations. The processor 620 can be single core, multiple core (e.g., quad core), or include more than one processing elements. The processor 620 can be disposed on silicon or any other suitable material. The processor 620 can receive and execute instructions and data stored in the memory 610 or the storage drive 630

The storage drive 630 can be any non-volatile type of storage such as a magnetic disc, EEPROM, Flash, or the like. The storage drive 630 stores code and data for applications.

The I/O port 640 further comprises a user interface 642 and a network input 644. The user interface 642 can output to a display device and receive input from, for example, a keyboard. The network input 644 can be a network plug or antennae and associated operating system software for integration with applications.

Many of the functionalities described herein can be implemented with computer software, computer hardware, computer firmware, or a combination.

Computer software products (e.g., non-transitory computer products storing source code) may be written in any of various suitable programming languages, such as C, C++, C#, Java, JavaScript, PHP, Python, Perl, Ruby, and AJAX. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Bluetooth, LTE, Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method for creating social networking connections using gestures, comprising:
receiving a first fingerprint of a gesture detected on a device of a first user, the gesture being indicative of the first user initializing a new social networking connection with a second user, the first fingerprint comprising at least an identification of the first user and a location of the device;
matching the first fingerprint to a second fingerprint received from the second user, the second fingerprint comprising at least an identification of the second user and a location of the second device, wherein the locations of the first and second devices are substantially matching; and
initiating a connection between the first and second users on a social network in response to the matching.

2. The method of claim 1, wherein the detected gesture comprises a tap, a shake, a vibration, or a bump, involving both the first and second devices.

3. The method of claim 1, wherein the gesture is detected by an accelerometer on a mobile device.

4. The method of claim 1, wherein the fingerprint comprises a measurement of first gesture intensity, and wherein matching the first fingerprint comprises substantially matching the first gesture intensity of the first device to a second gesture intensity of the second device.

5. The method of claim 1, wherein the fingerprint further comprises a time of the gesture, and wherein matching the first fingerprint comprises substantially matching the first gesture time to a second gesture time of the second device.

6. The method of claim 1, wherein initiating a connection between the first and second users on a social network comprises:
sending a command to a website of the social network to connect the first and second users.

7. The method of claim 6, wherein the command comprises a friend request.

8. The method of claim 6, wherein the command indicates consent by both the first and second users to complete a connection.

9. The method of claim 1, further comprising:
sending a verification request for the connection between the first and second users to the first and second users.

10. A non-transitory computer-readable medium storing source code that, when executed by a processor, performs a method for creating social networking connections using gestures, the method comprising:
receiving a first fingerprint of a gesture detected on a device of a first user, the gesture being indicative of the first user initializing a new social networking connection with a second user, the first fingerprint comprising at least an identification of the first user and a location of the device;
matching the first fingerprint to a second fingerprint received from the second user, the second fingerprint comprising at least an identification of the second user and a location of the second device, wherein the locations of the first and second devices are substantially matching; and
initiating a connection between the first and second users on a social network in response to the matching.

11. The computer-readable medium of claim 10, wherein the detected gesture comprises a tap, a shake, a vibration, or a bump, involving both the first and second devices.

12. The computer-readable medium of claim 10, wherein the gesture is detected by an accelerometer on a mobile device.

13. The computer-readable medium of claim 10, wherein the fingerprint comprises a measurement of first gesture intensity, and wherein matching the first fingerprint comprises substantially matching the first gesture intensity of the first device to a second gesture intensity of the second device.

14. The computer-readable medium of claim 10, wherein the fingerprint further comprises a time of the gesture, and wherein matching the first fingerprint comprises substantially matching the first gesture time to a second gesture time of the second device.

15. The computer-readable medium of claim 10, wherein initiating a connection between the first and second users on a social network comprises:
sending a command to a website of the social network to connect the first and second users.

16. The computer-readable medium of claim 15, wherein the command comprises a friend request.

17. The computer-readable medium of claim 15, wherein the command indicates consent by both the first and second users to complete a connection.

18. The computer-readable medium of claim 10, further comprising:
sending a verification request for the connection between the first and second users to the first and second users.

19. A computing device to create social networking connections using gestures, comprising:
a processor; and
a memory, comprising:
an accelerometer to detect a gesture associated with the device of a first user, the gesture being indicative of the first user initializing a new social networking connection with a second user, wherein the processor generates the first fingerprint to comprise at least an identification of the first user and a location of the computing device;
a network interface to send the first fingerprint to a server for matching with a second fingerprint received from the second user, the second fingerprint comprising at least an identification of the second user and a location of the second computing device, wherein the locations of the first and second computing devices are substantially matching, the network interface to receive an indication that a connection between the first and second users on a social network has been initiated by the server in response to the match.

20. The computing device of claim 19, wherein the computing device comprises a cellular telephone.
